(19) United States
(12) Patent Application Publication
(10) Pub. No.: US 2006/0190821 A1
(43) Pub. Date: Aug. 24, 2006

(54) Programmable object model for mathematical expressions

(75) Inventors: Jennifer P. Michelstein, Kirkland, WA (US); Ethan Joseph Bernstein, Seattle, WA (US); Jason Rajtar, Redmond, WA (US); Said Abou-Hallawa, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/067,378

(22) Filed: Feb. 22, 2005

(51) Int. Cl. G06F 15/00

(52) U.S. Cl. 715/538

(57) ABSTRACT

A programmable object model for one or more mathematical expressions in a section of a document. The model can include a buildup module programmed to build up the one or more mathematical expressions in the section. The model can include a linearize function module programmed to convert the one or more mathematical expressions in the section to a linear format. The model can also include an addition module programmed to convert a portion of the document to a mathematic expression, and a removal module programmed to remove mathematical formatting from the one or more mathematical expressions in the section. The model can further include a conversion module programmed to convert the one or more mathematical expressions in the section to MathML.

### RELATED APPLICATIONS

U.S. patent application Ser. No. 10/943,095, filed on Sep. 15, 2004 and entitled “Systems and Methods for Automated Equation Buildup,” and U.S. patent application Ser. No ______, Attorney Docket No. 310646.01/14917.58US01, filed on even date herewith and entitled “Extensible Markup Language Schema for Mathematical Expressions,” are hereby incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever.

### TECHNICAL FIELD

Embodiments of the present invention relate generally to programmable object models. More particularly, embodiments of the present invention relate to programmable object models for mathematical expressions.

### BACKGROUND

The ability to efficiently input mathematical expressions into word processing applications and html editors is becoming increasingly important as more technical information is distributed in word-processed and web page formats. Word processor programs and other similar types of programs allow users to create and edit mathematical expressions within the word-processing environment. For example, the word processor program MICROSOFT Word from MICROSOFT Corporation of Redmond, Wash., allows users to enter mathematical expressions into documents created using MICROSOFT Word.

It is desirable to provide programmable object models that allows for ease in the access and manipulation of mathematical expressions in documents.

### SUMMARY

Embodiments of the present invention relate to programmable object models for mathematical expressions.

One aspect of the invention relates to a programmable object model for one or more mathematical expressions in a section of a document, including a buildup module programmed to build up the one or more mathematical expressions in the section.

Another aspect of the invention relates to a method for programmatically accessing mathematical expressions in a section of a document, including: accessing the section via an object-oriented message call; and building up the one or more mathematical expressions in the section.

Yet another aspect of the invention relates to a computer-readable medium having computer-executable instructions for performing steps comprising: accessing the section via an object-oriented message call; and building up the one or more mathematical expressions in the section.

### BRIEF DESCRIPTION OF THE DRAWINGS

Reference will now be made to the accompanying drawings, which are not necessarily drawn to scale, and wherein:

FIG. 1 illustrates an example general purpose computing system;

FIG. 2 illustrates interaction between software objects according to an object-oriented programming model; and

FIG. 3 illustrates interaction between a document and a module programmed to access mathematical expression embedded in the document.

### DETAILED DESCRIPTION

Embodiments of the present invention will now be described more fully hereinafter with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Embodiments of the present invention relate generally to programmable object models. More particularly, embodiments of the present invention relate to programmable object models for mathematical expressions.

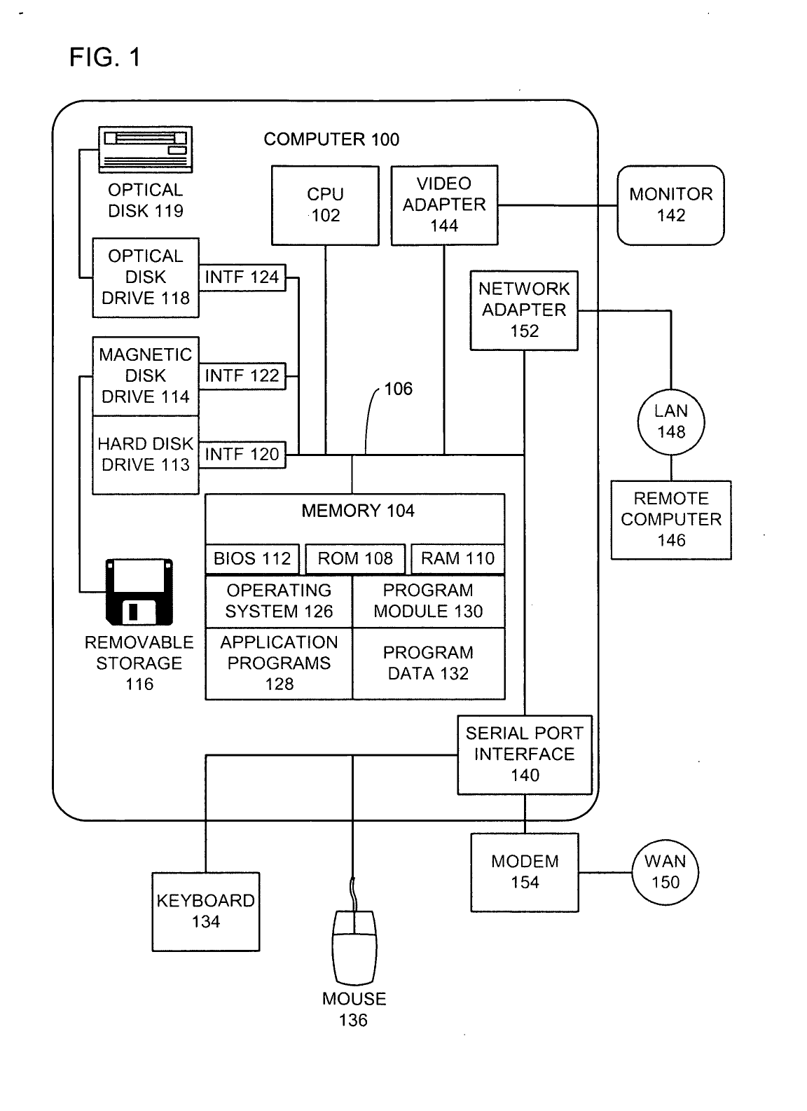

Referring now to FIG. 1, an example computer system 100 that can utilize a programmable object model is illustrated. The computer system 100 illustrated in FIG. 1 can take a variety of forms such as, for example, a desktop computer, a laptop computer, and a hand-held computer. In addition, although computer system 100 is illustrated, the systems and methods disclosed herein can be implemented in various alternative computer systems as well.

The system 100 includes a processor unit 102, a system memory 104, and a system bus 106 that couples various system components including the system memory 104 to the processor unit 102. The system bus 106 can be any of several types of bus structures including a memory bus, a peripheral bus and a local bus using any of a variety of bus architectures. The system memory includes read only memory (ROM) 108 and random access memory (RAM) 110. A basic input/output system 112 (BIOS), which contains basic routines that help transfer information between elements within the computer system 100, is stored in ROM 108.

The computer system 100 further includes a hard disk drive 113 for reading from and writing to a hard disk, a magnetic disk drive 114 for reading from or writing to a removable magnetic disk 116, and an optical disk drive 118 for reading from or writing to a removable optical disk 119 such as a CD ROM, DVD, or other optical media. The hard disk drive 113, magnetic disk drive 114, and optical disk drive 118 are connected to the system bus 106 by a hard disk drive interface 120, a magnetic disk drive interface 122, and an optical drive interface 124, respectively. The drives and their associated computer-readable media provide nonvolatile storage of computer readable instructions, data structures, programs, and other data for the computer system 100.

Although the example environment described herein can employ a hard disk 113, a removable magnetic disk 116, and a removable optical disk 119, other types of computer-readable media capable of storing data can be used in the example system 100. Examples of these other types of computer-readable mediums that can be used in the example operating environment include magnetic cassettes, flash memory cards, digital video disks, Bernoulli cartridges, random access memories (RAMs), and read only memories (ROMs).

A number of program modules can be stored on the hard disk 113, magnetic disk 116, optical disk 119, ROM 108, or RAM 110, including an operating system 126, one or more application programs 128, other program modules 130, and program data 132.

A user may enter commands and information into the computer system 100 through input devices such as, for example, a keyboard 134, mouse 136, or other pointing device. Examples of other input devices include a toolbar, menu, touch screen, microphone, joystick, game pad, pen, satellite dish, and scanner. These and other input devices are often connected to the processing unit 102 through a serial port interface 140 that is coupled to the system bus 106. Nevertheless, these input devices also may be connected by other interfaces, such as a parallel port, game port, or a universal serial bus (USB). An LCD display 142 or other type of display device is also connected to the system bus 106 via an interface, such as a video adapter 144. In addition to the display 142, computer systems can typically include other peripheral output devices (not shown), such as speakers and printers.

The computer system 100 may operate in a networked environment using logical connections to one or more remote computers, such as a remote computer 146. The remote computer 146 may be a computer system, a server, a router, a network PC, a peer device or other common network node, and typically includes many or all of the elements described above relative to the computer system 100. The network connections include a local area network (LAN) 148 and a wide area network (WAN) 150. Such networking environments are commonplace in offices, enterprise-wide computer networks, intranets, and the Internet.

When used in a LAN networking environment, the computer system 100 is connected to the local network 148 through a network interface or adapter 152. When used in a WAN networking environment, the computer system 100 typically includes a modem 154 or other means for establishing communications over the wide area network 150, such as the Internet. The modem 154, which can be internal or external, is connected to the system bus 106 via the serial port interface 140. In a networked environment, program modules depicted relative to the computer system 100, or portions thereof, may be stored in the remote memory storage device. It will be appreciated that the network connections shown are examples and other means of establishing a communications link between the computers may be used.

The embodiments described herein can be implemented as logical operations in a computing system. The logical operations can be implemented (1) as a sequence of computer implemented steps or program modules running on a computer system and (2) as interconnected logic or hardware modules running within the computing system. This implementation is a matter of choice dependent on the performance requirements of the specific computing system. Accordingly, the logical operations making up the embodiments described herein are referred to as operations, steps, or modules. It will be recognized by one of ordinary skill in the art that these operations, steps, and modules may be implemented in software, in firmware, in special purpose digital logic, and any combination thereof without deviating from the spirit and scope of the present invention as recited within the claims attached hereto. This software, firmware, or similar sequence of computer instructions may be encoded and stored upon computer readable storage medium and may also be encoded within a carrier-wave signal for transmission between computing devices.

Exemplary embodiments of the present invention can be implemented by communications between different software objects in an object-oriented programming environment. For purposes of the following description of example embodiments, it is useful to briefly to describe components of an object-oriented programming environment.

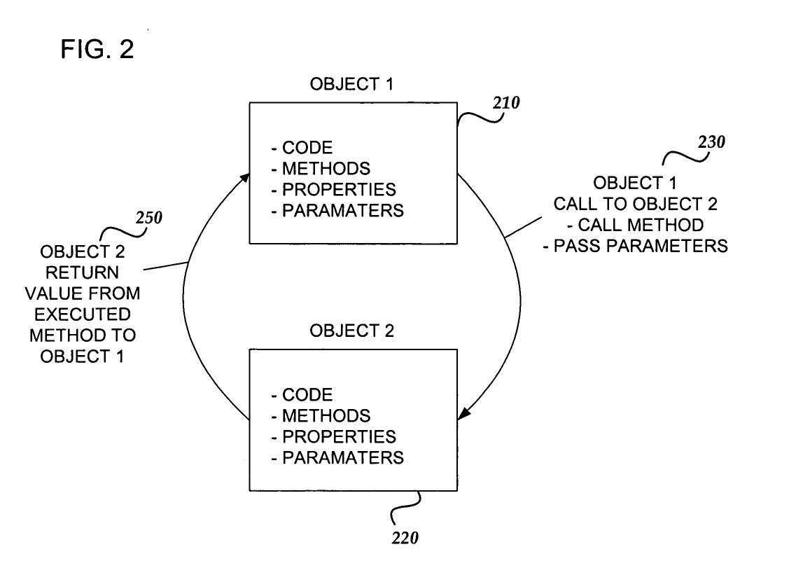

Referring now to FIG. 2, a simplified block diagram illustrating interaction between software objects according to an object-oriented programming model is shown. According to an object-oriented programming environment, a first object 210 can include software code, executable methods, properties, and parameters. Similarly, a second object 220 can also include software code, executable methods, properties, and parameters.

A first object 210 can communicate with a second object 220 to obtain information or functionality from the second object 220 by calling the second object 220 via a message call 230. As is well know to those skilled in the art of object-oriented programming environment, the first object 210 can communicate with the second object 220 via application programming interfaces (API) that allow two disparate software objects 210, 220 to communicate with each other in order to obtain information and functionality from each other.

For example, if the first object 210 requires the functionality provided by a method contained in the second object 220, the first object 210 can pass a message call 230 to the second object 220 in which the first object identifies the required method and in which the first object passes any required parameters to the second object required by the second object for operating the identified method. Once the second object 220 receives the call from the first object, the Attorney Docket No. 310645.01/14917.57 US 01 second object executes the called method based on the provided parameters and sends a return message 250 containing a value obtained from the executed method back to the first object 210.

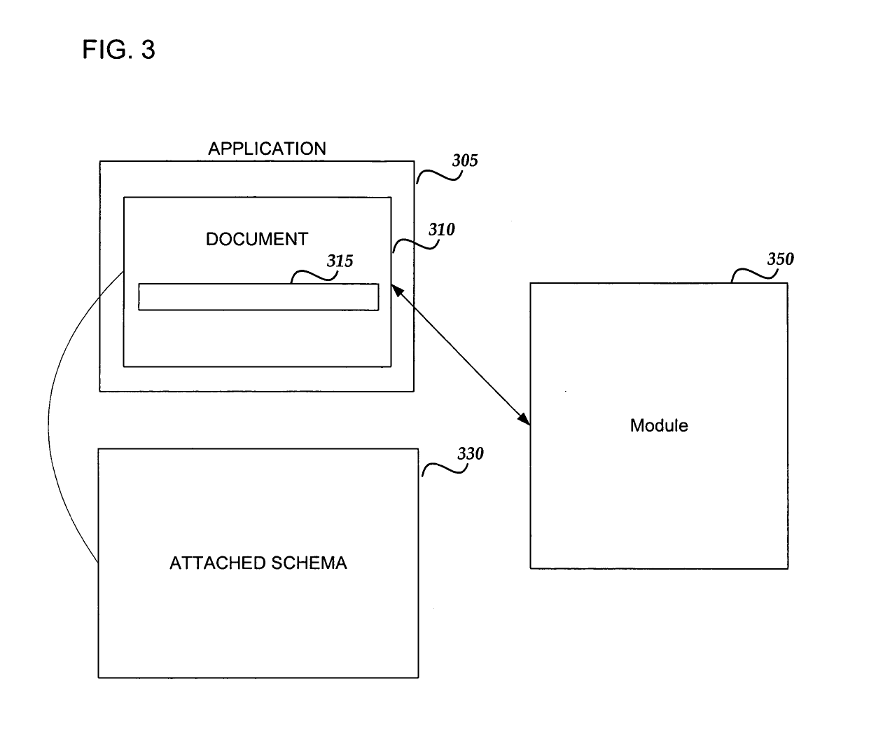

Referring now to FIG. 3, an example block diagram is provided illustrating interaction between a document 310, an attached XML schema 330 defining portions of the document 310 (including mathematical expressions therein), and a module 350 that accesses portions of the document 310. Document 310 can be saved according to a variety of different file formats and according to the native programming language of the application 305 with which the document 310 is created.

Various mathematical expressions 315 can be included in document 310 using, for example, application 305. According to example embodiments, an object-oriented programming model is provided to allow module 350 to access and/or manipulate mathematical expressions embedded in document 310 via a set of application programming interfaces or object-oriented message calls either directly through one or more application programming interfaces or programmatically through other software application programs written according to a variety of programming languages such as, for example C, C++, C#, Visual Basic, and the like.

In some embodiments, module 350 can be a plug-in to application 305, or a standalone application that can be used to access and/or manipulate mathematical expressions 315 in document 310. For example, module 350 can be used to count the number of mathematical expressions 315 in document 310, or can be used to revise the mathematic expressions 315 so that each expression conforms to a standard.

The XML schema 330 used to define the mathematical expressions 315 in document 310 can take a variety of forms. In one example, the XML schema 330 is configured according to that disclosed in U.S. patent application Ser. No. ______, Attorney Docket No. 310646.01/14917.58US01, filed on even date herewith and entitled “Extensible Markup Language Schema for Mathematical Expressions.” In another example, the XML schema 330 is configured according to the Mathematical Markup Language (MathML) Version 2.0 (Second Edition), dated Feb. 21, 2001, from the World Wide Web Consortium (W3C) Math working group.

The following is a description of objects and associated properties comprising application programming interfaces (API) or object-oriented message calls that provide access to the mathematical expressions in documents. Following each of the objects or associated properties set out below is a description of the operation and functionality of the object or associated property.
OMath—is a section of a document including one or more mathematical expressions.
OMaths—is a collection of sections of a document including one or more mathematical expressions.
OMaths(n)—returns the nth OMath object in an OMath collection.
OMaths(n).OMathFunctions(n)—returns the nth OMathFunction object in a OMathFunction collection.
Font.OMath—allows for the toggling on and off of OMath formatting for the selected section.
   The following can be children of the OMaths object.
   .Add—converts a range to OMath formatting.
   Buildup builds up the referenced OMath object(s) from a linear format to a two-dimensional format (using a non-linear two-dimensional notation such as, for example, Polish prefix format) using, for example, formula autobuildup. Additional details regarding formula autobuildup can be found in U.S. patent application Ser. No. 10/943,095, filed on Sep. 15, 2004 and entitled “Systems and Methods for Automated Equation Buildup.” If no section is specified, formula autobuildup acts on all sections in its parent element.
   .Count returns the number of OMath objects in a collection.
   Linearize—converts the referenced OMath object(s) to linear format (from, for example, a two-dimensional format such as a Polish prefix notation). Linear format is a linear text-based representation of an equation using a linear notation such as, for example, a linear string format such as that disclosed in U.S. patent application Ser. No. 10/943,095, filed on Sep. 15, 2004 and entitled “Systems and Methods for Automated Equation Buildup.” Other linear formats such as TeX or LaTeX can also be used. If no section is specified, all sections in its parent element are converted to linear format.
   OMaths( )—A collection of OMath objects.
      The following can be children of the OMath object.
   .Buildup builds up the referenced OMath object from a linear format to a two-dimensional format (using a non-linear two-dimensional notation such as, for example, Polish prefix format) using, for example, formula autobuildup. Additional details regarding formula autobuildup can be found in U.S. patent application Ser. No. 10/943,095, filed on Sep. 15, 2004 and entitled “Systems and Methods for Automated Equation Buildup.” If no section is specified, formula autobuildup acts on all sections in its parent element.
   Functions—an OMathFunctions object.
   Linearize—converts the referenced OMath object to linear format (from, for example, a two-dimensional format such as a Polish prefix notation). Linear format is a linear text-based representation of an equation using a linear notation such as, for example, a linear string format such as that disclosed in U.S. patent application Ser. No. 10/943,095, filed on Sep. 15, 2004 and entitled “Systems and Methods for Automated Equation Buildup.” Other linear formats such as TeX or LaTeX can also be used. If no section is specified, all sections in its parent element are converted to linear format.
   .MathML—is a read-only object that returns the MathML representation of the specified OMath object as a string.
   .Range returns the contents of the referenced OMath object.
   Remove deletes OMath formatting from the referenced OMath object but keeps the text in place.
   .Style is the style (display or inline) of the referenced OMath object. Display style is expressed in typical two-dimensional (e.g., Polish prefix) format. Inline style is compressed so that changes in line spacing of surrounding text are minimized.
   .Type returns either Display (the only text contained in the paragraph is math text) or Inline (in a paragraph that also includes text outside of the math region) depending on the referenced region.
      The following can be children of the OMathFunctions object.
   .Add creates a new OMathFunctions object at a specified range of a specified type (e.g., delimiter—specify number of arguments with a default of 1, matrix—specify number of columns and rows, etc.)
   .Count returns the number of OMathFunction objects in a collection.
   .OmathFunctions( )—a collection of OMathFunction objects.
      The following can be children of the OMathFunction object.
   .Acc is the object including a base and a combining mark above.
      .E is a read-write argument that returns the accent base as OMath.
      .Char is a read-write property that returns the accent mark as int, representing the character code of the accent mark.
   .Args is the collection of OMath items which represent each argument in the function.
      Count returns the number of arguments in the referencedOMathFunction object.
   .Bar is an object including a base with an overbar or underbar.
      .BarTop is a read-write property that returns Boolean (returns True for overbar, False for underbar).
      .E is a read-write argument that returns the base as OMath.
   .Box is an object including a base that defines the spacing around the object.
      .E is a read-write argument that returns the base as OMath.
   .Delim is the object for brackets, braces, parentheses, and vertical bar braces.
      .Args is the collection of arguments between separators inside the delimiters.
      .BegChar is a read-write property that returns the opening character as int, representing the character code of the opening character.
      .EndChar is a read-write property that returns the closing character as int, representing the character code of the closing character.
      .Grow is a read-write property that returns Boolean (True for grow, False for match).
      .SepChar is a read-write property that returns the separator character as int, representing the character code of the separator character.
      Shape is a read-write property (0 for centered, 1 for match).
   .EqArray is the object that contains at least one equation.
   .Frac is the object for stacked, skewed, no-bar, and linear fractions.
      .AlignBase is a read-write property that returns 0 for centered, 1 for bottom-aligned, and 2 for top-aligned.
      .AlignDen is a read-write property that returns 0 for centered, 1 for left-aligned, and 2 for right-aligned.
      .AlignNum is a read-write property that returns 0 for centered, 1 for left-aligned, and 2 for right-aligned.
      .Den is a read-write argument that returns the denominator as OMath.
      .Num is a read-write argument that returns the numerator as OMath.
      .Type is a read-only property that returns 0 for stacked, 1 for skewed, 2 for linear, 3 for no-bar.
   .Func is the function apply object, used for functions including sin, cos, and tan.
      .E is a read-write argument that returns the base as OMath.
      .FName is a read-write argument that returns the function name as OMath.
   .GroupChar is the object with a grouping character, such as a horizontal brace, either above or below the base.
      .Char is a read-write property that returns the grouping character as int, representing the character code of the grouping character.
      .E is a read-write argument that returns the base as OMath.
      .GroupCharBottom is a read-write property that returns the location of the group character as Boolean (True for bottom, False for top).
   .LimLow is the object including text with smaller text below it (example: limit from n to infinity).
      .E is a read-write argument that returns the base as OMath.
      .Lim is a read-write argument that returns the text below as OMath.
   .LimUpp is the object including text with smaller text above it.
      .E is a read-write argument that returns the base as OMath.
      .Lim is a read-write argument that returns the text above as OMath.
   .Mat is a matrix object.
      Align is a read-write property that returns an int (0 for centered, 1 for bottom-aligned, and 2 for top-aligned).
      .Cell accepts a row number and column number of a specified cell and returns the particular OMath argument for the specified cell.
      .Col accepts a column number of a specified column and returns .MatCol (described below) for the specified column.
         .MatCol is a particular column of a matrix.
            .Align is a read-write property that returns 0 for centered, 1 for left-aligned, and 2 for right-aligned.
            .Args is a collection of OMath objects which represent the cells in a particular column.
      .Row accepts a row number of a specified row and returns .MatRow (described below) for the specified row.
         .MatRow is a particular row of a matrix.
            .Align is a read-write property that returns 0 for centered, and 1 for bottom-aligned.
            .Args is a collection of OMath objects which represent the cells in a particular row.
   .Nary is the object for all n-ary operators.
      .Char is a read-write property that returns the nary character as int, representing the character code of the nary character.
      .E is a read-write argument that returns the base as OMath.
      .Grow is a read-write property that returns a Boolean (True for grow, False for match)
      .Sub is a read-write argument that returns the lower limit as OMath.
      .SubSupLim is a read-write property that returns a Boolean (True for Sub-Sup location, False for Over-Under location)
      .Sup is a read-write argument that returns the upper limit as OMath.
   .Rad is a radical object including a radicand and degree.
      .Deg is a read-write argument that returns the degree as OMath.
      .E is a read-write argument that returns the radicand as OMath.
   .Range returns the contents of the referenced OMathFunction object.
   .ScrPre is the object including a base with a superscript and subscript before the base.
      .E is a read-write argument that returns the base as OMath.
      .Sub is a read-write argument that returns the subscript as OMath.
      .Sup is a read-write argument that returns the superscript as OMath.
   .ScrSub is the object including a base and subscript.
      .E is a read-write argument that returns the subscript base as OMath.
      .Sub is a read-write argument that returns the subscript as OMath.
   .ScrSubSup is the object including a base with a superscript and subscript after the base.
      .E is a read-write argument that returns the subscript-superscript base as OMath.
      .Sub is a read-write argument that returns the subscript as OMath.
      .Sup is a read-write argument that returns the superscript as OMath.
   .ScrSup is the object including a base and superscript.
      .E is a read-write argument that returns the superscript base as OMath.
      .Sup is a read-write argument that returns the superscript as OMath.
   .Type returns the type of function as a value or text string.

The example object model disclosed above allows users to access and manipulate mathematical expressions in documents. For example, an example code section provided below illustrates use of the object model to find every instance in a document where a fraction is a top-level level object in the numerator or denominator of a top-level fraction—i.e., a/b/c/d rather than as

Dim om As OMath
Dim mf As OMathFunction
Dim mfNested As OMathFunction
For Each om In ActiveDocument.OMaths

For Each mf In om.OMathFunctions

If mf.Type = wdMathObjectFrac Then

For Each mfNested In mf.Frac.Num.OMathFunctions

If mfNested.Type = wdMathObjectFrac Then

mfNested.Frac.Type = wdMathFracLin

End If

End If
For Each mfNested In mf.Frac.Den.OMathFunctions

If mfNested.Type = wdMathObjectFrac Then

mfNested.Frac.Type = wdMathFracLin

End If

End If

End If

Next mf

Next om

In another example, the example code provided below determines if a selection is a fraction where the numerator and denominator are both integers and generates a message box with the value of the integer division described by the selected fraction.

dim f as MathFrac
If (Selection.OMaths.Count = 1) And
(Selection.OMaths(1).OMathFunctions.Count = 1)
And (Selection.OMaths(1).OMathFunctions(1).Type =
wdMathObjectFrac) Then

set f = Selection.OMaths(1).OMathFunctions(1).Frac
If (IsInteger(f.Num.Range.Text)) And IsInteger(f.Den.Range.Text))

MsgBox Int(f.Num.Range.Text) / Int(f.Num/Range.Text)

End If

End If

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

The claimed invention is:

1. A programmable object model for one or more mathematical expressions in a section of a document, comprising a buildup module programmed to build up the one or more mathematical expressions in the section.

2. The programmable object model of claim 1, further comprising a linearize function module programmed to convert the one or more mathematical expressions in the section to a linear format.

3. The programmable object model of claim 2, further comprising an addition module programmed to convert a portion of the document to a mathematical expression.

4. The programmable object model of claim 2, further comprising a removal module programmed to remove mathematical formatting from the section.

5. The programmable object model of claim 1, further comprising an addition module programmed to convert a portion of the document to a mathematical expression.

6. The programmable object model of claim 1, further comprising a removal module programmed to remove mathematical formatting from the section.

7. The programmable object model of claim 1, further comprising a conversion module programmed to convert the one or more mathematical expressions in the section to MathML.

8. A method for programmatically accessing mathematical expressions in a section of a document, comprising:
accessing the section via an object-oriented message call; and
building up the one or more mathematical expressions in the section.

9. The method of claim 8, further comprising converting the one or more mathematical expressions in the section to a linear format.

10. The method of claim 9, further comprising converting a portion of the document to a mathematical expression.

11. The method of claim 9, further comprising removing mathematical formatting from the one or more mathematical expressions in the section.

12. The method of claim 8, further comprising converting a portion of the document to a mathematical expression.

13. The method of claim 8, further comprising removing mathematical formatting from the one or more mathematical expressions in the section.

14. The method of claim 8, further comprising converting the one or more mathematical expressions in the section to MathML.

15. A computer-readable medium having computer-executable instructions for performing steps comprising:
accessing the section via an object-oriented message call; and
building up the one or more mathematical expressions in the section.

16. The computer-readable medium of claim 15, further comprising converting the one or more mathematical expressions in the section to a linear format.

17. The computer-readable medium of claim 16, further comprising converting a portion of the document to a mathematical expression.

18. The computer-readable medium of claim 15, further comprising converting a portion of the document to a mathematical expression.

19. The computer-readable medium of claim 15, further comprising removing mathematical formatting from the one or more mathematical expressions in the section.

20. The computer-readable medium of claim 15, further comprising converting the one or more mathematical expressions in the section to MathML.
